(19) United States
(12) Patent Application Publication
(10) Pub. No.: US 2007/0056530 A1
(43) Pub. Date: Mar. 15, 2007

(54) Disposable pet garment

(76) Inventor: Jody Nassour, El Paso, TX (US)

Correspondence Address: R WAYNE PRITCHARD, 300 EAST MAIN, SUITE 1240, EL PASO, TX, 79901, US

(21) Appl. No.: 11/226,022

(22) Filed: Sep. 14, 2005

(51) Int. Cl. A01K 13/00

(52) U.S. Cl. 119/850

(57) ABSTRACT

A disposable pet garment used to reduce pet dander and the release of unwanted pet hair made of lightweight, resilient, breathable material containing electrostatic properties is disclosed.

### BACKGROUND OF THE INVENTION

1. Field of the Invention

This invention relates to a lightweight, disposable pet garment. More particularly, this invention relates to a lightweight disposable pet garment containing electrostatic properties used to reduce pet dander and the release of unwanted pet hair.

2. Description of the Prior Art

Certainly, the idea of putting clothes on a pet is not novel. The prior art is filled with examples of pet clothing in as many different shapes and sizes as there are pets. As early as 1940, Florence Conlon obtained a U.S. Patent on a “Dog Cover”, U.S. Pat. No. 2,222,705, in which she disclosed a cover that would fit most dogs and would cover the dog from paw to head to prevent scratching and shedding while the dog was being transported. More recently, Kimberly D. Harrell in U.S. Pat. No. 6,058,890, entitled Water Absorbent Robe for Pets, has disclosed a water absorbent robe for dogs designed to keep a dog from trying to dry itself by shaking. Joseph S. Sporn in U.S. Publication Number US2003/0029389 A1, entitled Disposable Raingear for Pets, has disclosed basically a rain coat for pets. Ronals C. Jesse, Sr., in U.S. Pat. No. 6,024,055, entitled Dog Sweater with Integral Legs has designed a piece of clothing for a dog to keep a dogwarm in winter. Not recognized by any of the prior art is the fact that, just as humans, a pet's skin must be allowed to “breathe” in order to allow for body cooling sufficient to keeps the pet from overheating. The disposable pet garment of the present invention is unlike any of the prior art in that it provides lightweight, breathable, disposable pet clothing containing electrostatic properties, developed for the purposes of reducing pet dander and the release of unwanted pet hair.

### SUMMARY OF THE INVENTION

It is, therefore, an object of the present invention to provide a lightweight, breathable, disposable pet garment which contains electrostatic properties to reduce pet dander and the release of unwanted pet hair. Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is an illustration of the disposable pet garment of the present invention looking from the underneath.

FIG. 2 illustrates the disposable pet garment ofthe present invention as worn on various types of dogs showing various design details.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as the basis for the claims and as a basis for teaching one skilled in the art how to make and/or use the invention.

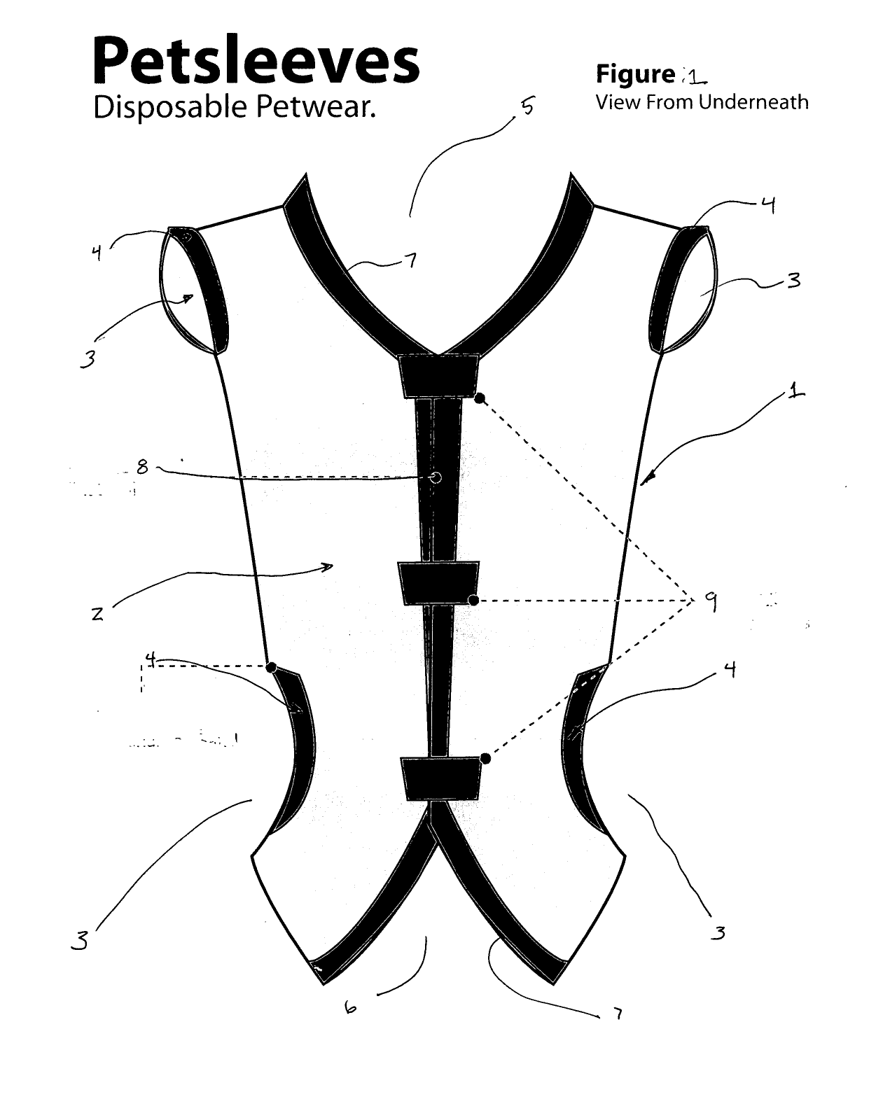

While the current invention envisions use in connection with common household pets such as dogs or cats, the invention can be made to fit just about any four legged animal. With reference to FIG. 1, a disposable pet garment [1] is disclosed which in general consists of rectangular sheet [2] of breathable, resilient material. Although the current invention envisions the use of a single ply non-woven material, the invention can be made using multiple plies as well as by using woven material such as cotton. Additionally, as discussed below, while openings in the current invention are surrounded with elastic, the non woven material could be made elastic eliminating the need for the elastic closures. Further, while the current invention is made to be disposable, i.e., for single use, depending on the actual use, it may, in fact, be used for several applications and, could be made of different, reusable woven or non woven material.

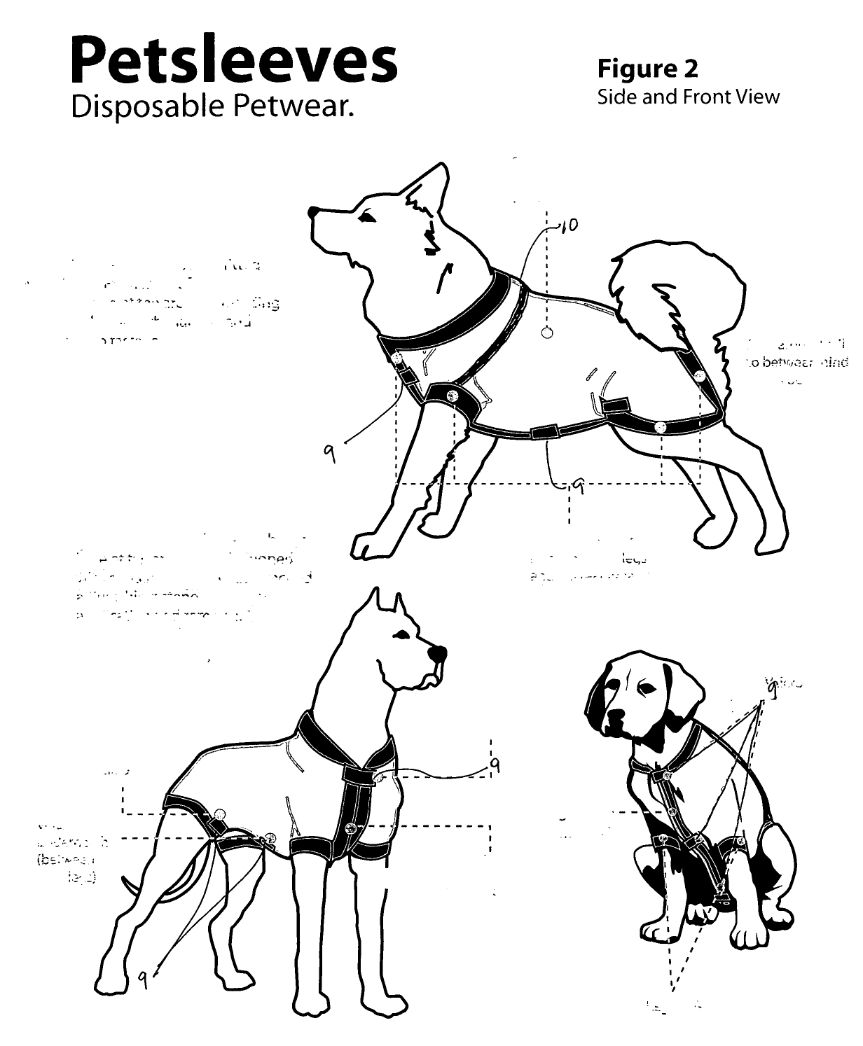

Located in and on the surface of the rectangular sheet [2] that will come into contact with the pet's body is an electrostatic material [9]. Along the elongated edges of the rectangular sheet of material are openings [3] in the general vicinity of where a pet's legs would be. The circumference of each leg opening [3] is surrounded by a material elastic in nature [4] such that a fitted cuff can be achieved around the pet's leg. The elastic material [4] can be attached to the opening [3] using any conventional means such as stitching, glue or thermally activated attachment means. At opposite ends of the rectangular sheet are openings for the head [5] and tail [6] of the pet. The head [5] and tail [6] openings are, like the leg openings [3], surrounded by an elastic material [7] so a comfortable fitted closure can be achieved. As can be seen from FIG. 2, the rectangular sheet is fitted on the pet by placing the pet's head, tail and legs through the head [5], tail [6] and leg openings [3], respectively. An elastic strap [10] can be attached, using any conventional means, to the pet garment of the present invention between the openings for the front legs to provide for better fit across the back of the pet. Although the genital area of the pet in the current invention is not covered, a covering could easily be attached made of absorbent material so that feces and/or urine could be contained.

As shown in both FIGS. 1 and 2, the two elongated edges of the rectangular sheet are attached to each other using any conventional means such as hook and loop type fasteners [9]. Although not necessary in the preferred embodiment, an elastic type material can be attached [8] to the elongated edges for increased flexibility in fitting. The pet clothing of the present invention can be impregnated with various perfumes, allergen reducing products or other substances that will improve the odor or health of either the pet, the pet surroundings or the people coming into contact with the pet The current invention can be used by homeowners in ordinary household situations to reduce pet hair or dander indoors; can be used by veterinarians to reduce the capability of a pet from licking a surgical site; and could be used in the context of animal exhibitions so that freshly cleaned animals will remain clean.

While the preferred embodiments have been shown and described, it will be understood that there is no intent to limit the invention by such disclosure, but rather, is intended to cover all modifications and alternate constructions fallingwithin the spirit and scope of the invention as defined in the appended claims.

1. A pet garment comprising a sheet of lightweight, resilient, breathable fabric of sufficient size and shape to adequately cover primarily the torso region of a four legged pet with openings for the head, tail and the four legs of said pet; and a means for attaching said sheet together along the underneath of said pet.

2. The pet garment of claim 1 wherein said garment contains electrostatic properties.

3. The pet garment of claim 1 wherein elastic material is attached along the circumference of each said opening.

4. The pet garment of claim 1 wherein said garment is impregnated with odor reducing substances.

5. The pet garment of claim 1 wherein said garment is impregnated with germ reducing substances.

6. The pet garment of claim 5 wherein the germ reducing substance is anti-bacterial.

7. The pet garment of claim 1 wherein the garment is impregnated with an antiviral substance.

8. The pet garment of claim 1 wherein said garment is impregnated with pest avoidance substances.

9. The pet garment of claim 1 wherein a genital covering is attached between the openings for the rear legs.

10. The pet garment of claim 9 wherein the genital covering is made from absorbent material.

11. A pet garment comprising a sheet of lightweight, resilient, breathable fabric of sufficient size and shape to adequately cover primarily the torso region of a four legged pet with openings for the head, tail and the four legs of said pet; an elastic strap attached between the openings for the front legs and a means for attaching said sheet together along the underneath of said pet.

12. The pet garment of claim 11 wherein said garment contains electrostatic properties.

13. The pet garment of claim 11 wherein elastic material is attached along the circumference of each said opening.

14. The pet garment of claim 11 wherein said garment is impregnated with odor reducing substances.

15. The pet garment of claim 11 wherein said garment is impregnated with germ reducing substances.

16. The pet garment of claim 15 wherein the germ reducing substance is anti-bacterial.

17. The pet garment of claim 15 wherein the garment is impregnated with an antiviral substance.

18. The pet garment of claim 11 wherein said garment is impregnated with pest avoidance substances.

19. The pet garment of claim 11 wherein a genital covering is attached between the openings for the rear legs.

20. The pet garment of claim 19 wherein the genital covering is made from absorbent material.
